(19) United States
(12) Patent Application Publication
(10) Pub. No.: US 2017/0005416 A1
(43) Pub. Date: Jan. 5, 2017

(54) MULTI-BEAM PHASED ARRAY ANTENNA

(71) Applicant: RAYTHEON COMPANY, Waltham, MA (US)

(72) Inventors: Craig D. Gendron, Holden, MA (US); John Magnani, Framingham, MA (US); Alan Palevsky, Wayland, MA (US); Cameron Thorpe, Amherst, MA (US); Darrin T. Jacque, Lancaster, MA (US); Vincent P. D'Andrea, Randolph, MA (US)

(21) Appl. No.: 14/788,579

(22) Filed: Jun. 30, 2015

(51) Int. Cl. H01Q 25/00; H01Q 1/38; H01Q 9/04; H01Q 3/26

(52) U.S. Cl. CPC H01Q 25/00; H01Q 3/26; H01Q 1/38; H01Q 9/0407

(57) ABSTRACT

A multi-beam antenna array includes a receiver multi-layer circuit card assembly (CCA) comprising of a first plurality of monolithic microwave integrated circuits (MMICs), a first plurality of radiating elements, and a first plurality of interconnections; a transmitter multi-layer CCA comprising of a second plurality of MMICs, a second plurality of radiating elements, and a second plurality of interconnections; and a single aperture shared by the receiver multi-layer CCA and the transmitter multi-layer CCA, where each of the first and second plurality of MMICs includes mixed analog and digital circuits surface mounted onto said each MMIC.

### FIELD OF THE INVENTION

The present invention relates generally to antennas and more specifically to a multi-beam phased array antenna.

### BACKGROUND

An antenna is a transducer, which transmits or receives electromagnetic waves. Antennas include one or more elements, which are conductors that can radiate and or receive electromagnetic waves. These elements are often referred to as radiators with a collection of radiators referred to as an aperture. When transmitting, an alternating current is created in the element(s) by application of a voltage at the terminals of the antenna, which causes the element(s) to radiate an electromagnetic field. When receiving, an electromagnetic field from a remote source induces an alternating current in the elements generating a corresponding voltage at the terminals of the antenna.

An antenna array is a group of multiple active antennas coupled to a common source or load to produce a directive radiation pattern. Usually, the spatial relationship of the individual antennas also contributes to the directivity of the antenna array. A phased array antenna is an array of antennas in which the relative phases of the signals feeding the antennas are varied in a manner that the effective radiation pattern of the entire array is reinforced in a desired direction and suppressed in undesired directions.

FIG. 1 shows a diagram of a conventional antenna array 100. The antenna array 100 includes several linear arrays 104 housed in a (non-metallic) radome 102. Here, each linear array 104 is arranged vertically with spacing between each other, which is determined by the desired frequency and scan angle of the antenna array 100. Each linear array 102 is connected to its associated radio frequency (RF) electronics circuitry contained in an external RF electronics module 108, via an antenna feed 106. The RF electronics module 108 is connected to external systems via a connection 110 for power, control, and communications connections; and may be physically mounted on the radome 102, or may be located remotely or outside of the antenna array 100.

An Electronically Scanned Array (ESA) is a type of phased array antenna, in which transceivers include a large number of solid-state transmit/receive modules. In ESAs, an electromagnetic beam is emitted by broadcasting radio frequency energy that interferes constructively at certain angles in front of the antenna. An active electronically scanned array (AESA) is a type of phased array radar whose transmitter and receiver (transceiver) functions are composed of numerous small solid-state transmit/receive modules (TRMs). These modules are active since they have electronic gain. AESA antennas aim their beam by emitting separate radio waves from each module that interfere constructively at certain angles in front of the antenna.

Modern radar, radar jammer and communications antenna systems often require wideband frequency capability within constrained volume allocations. Electronically Scanned Array (ESA) antenna and Active Electronically Scanned Array (AESA) antenna designs provide dense-packed, high-reliability electronics, but ESA or AESA component limitations typically require that wideband frequency applications be broken up into multiple bands for hardware implementation. These bandwidth-limited components may include circulators, power amplifiers, or manifolding, and wideband partitioning typically results in the need for multiple antenna assemblies with each additional antenna requiring volume, weight, and cost allocations.

Typical wideband antenna applications use separate antenna assemblies for each performance frequency band. That is, one antenna assembly including its own aperture (reflector) is used for a first band, and a separate antenna assembly including its own aperture (reflector) is used for a second band. Moreover, existing phased array antennas utilize separate transmit/receive (T/R) modules, which results in larger size and weight and higher cost.

The present invention provides a low cost, low weight solution to the wideband antenna arrays by packaging multi-band RF communication links in one antenna assembly with a single reflector.

### SUMMARY

In some embodiments, the present invention is an RF circuit card assembly (CCA)-based phased array antenna with a single microwave monolithic integrated circuit (MMIC) at each antenna element. The antenna array of the present invention is a multi-beam phased array antenna, which can be used for line of sight (LOS) communications, among other applications. In some embodiments, the antenna array of the present invention includes four simultaneous RF communication links on the receive side and two simultaneous RF communication links on the transmit side, each in a single circuit card assembly. In some embodiments, the invention also provides beam steering agility and configurability for multiple polarizations (horizontal vertical, RHCP or LHCP) operations.

In some embodiments, the present invention is a multi-beam antenna array, which includes a receiver multi-layer circuit card assembly (CCA) comprising of a first plurality of monolithic microwave integrated circuits (MMICs), a first plurality of radiating elements, and a first plurality of interconnections; a transmitter multi-layer CCA comprising of a second plurality of MMICs, a second plurality of radiating elements, and a second plurality of interconnections; and a single aperture shared by the receiver multi-layer CCA and the transmitter multi-layer CCA. Each of the first and second plurality of MMICs includes mixed analog and digital circuits surface mounted onto said each MMIC and a thermometer circuitry, each of the first and second plurality of radiating elements is a two-port radiating element for multiple polarization modes of operations. Moreover, the first and second plurality of interconnections include a single serial bus for addressing each of the respective plurality of MMICs, a first and second plurality of beam forming circuits, respectively and etched on respective layers of a respective CCA, and a plurality of controlled impedance RF via contacts to interconnect corresponding circuits and layers of a respective multi-layer CCA.

In some embodiments, the present invention is a multi-beam antenna array, which includes a plurality of receiver multi-layer circuit card assemblies (CCAs), each receiver multi-layer CCA comprising of a first plurality of monolithic microwave integrated circuits (MMICs), a first plurality of radiating elements, and a first plurality of interconnections; a plurality of transmitter multi-layer CCAs, each transmitter multi-layer CCA comprising of a second plurality of MMICs, a second plurality of radiating elements, and a second plurality of interconnections; and a single aperture shared by the plurality of receiver multi-layer CCAs and the plurality of transmitter multi-layer CCAs. Each of the first and second plurality of MMICs includes mixed analog and digital circuits surface mounted onto said each MMIC, and the first and second plurality of interconnections include a first and second plurality of beam forming circuits, respectively and etched on respective layers of a respective CCA, and a plurality of controlled impedance RF via contacts to interconnect corresponding circuits and layers of a respective multi-layer CCA.

Each of the first plurality of MMICs may further include a low noise amplifier and each of the second plurality of MMICs include a power amplifier. In some embodiments, the first and second plurality of radiating elements may be feed and slot-couple radiator elements. In some embodiments, each of the feed and slot coupled radiator elements may include a patch antenna element and a pair of excitation circuits and each of the excitation circuits include a feed line and a tuning circuit configured such that a single feed line enables independent operation of each polarization of the multi-beam antenna array.

In some embodiments, the mixed analog and digital circuits in each of the MMICs may include analog circuitry for controlling the amplitude, phase and attenuation of respective radiating elements for the multiple polarization modes of operations. In some embodiments, the mixed analog and digital circuits are implemented using silicon-germanium (SiGe).

### BRIEF DESCRIPTION OF THE DRAWINGS

These and other features, aspects, and advantages of the present invention will become better understood with regard to the following description, appended claims, and accompanying drawings.

FIG. 1 shows a diagram of a conventional antenna array.

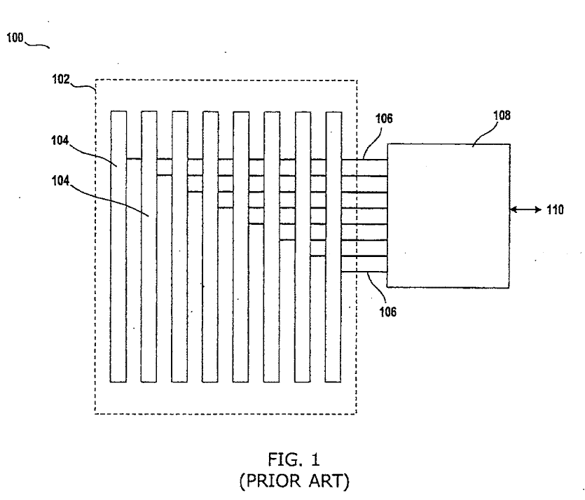

FIGS. 2A-2C illustrate a mechanical packaging of a multi-beam phased array antenna, according to some embodiments of the present invention.

FIG. 3 depicts an exemplary controlled impedance RF via contact, according to some embodiments of the present invention.

FIG. 4 illustrates the integration of the elements of a multi-beam phased array antenna into a single circuit card assembly (CCA), according to some embodiments of the present invention.

FIG. 5 shows an exemplary transmit (Tx) circuit or receive (Rx) card assembly (CCA), according to some embodiments of the present invention.

FIG. 6 shows an exemplary array of beam forming circuits etched on a circuit card assembly (CCA), according to some embodiments of the present invention.

FIG. 7 illustrates a beam forming circuit that is etched on a circuit card assembly (CCA), according to some embodiments of the present invention.

### DETAILED DESCRIPTION

In some embodiments, the present invention is a high-performance and low-cost multi-beam phased array antenna, which increases the reliability and number of simultaneous wideband radio frequency (RF) data links of a phased array antenna, for example, aboard a ship for both networking and persistent surveillance. For the navy ships applications, the invention allows multiple surface-to-air links without taking up valuable topside real estate aboard the ship. In some embodiments, the present invention includes an air-cooled or water cooled multi-beam (4 beam/8 channel) receive (Rx) monolithic microwave integrated circuit (MMIC) and circuit card assembly (CCA) building block for a Rx phased array subsystem. In addition, the invention includes an air-cooled or water cooled multi-beam (2 beam/4 channel) transmit (Tx) MMIC and CCA building block for a Tx phased array subsystem.

A Ku-band common data link (CDL) AESA, according to the present invention, receives real-time intelligence, surveillance, and reconnaissance (ISR) data simultaneously from multiple sources and exchanges command and control information across dissimilar joint, service, coalition, and civil networks. In addition, the Ku-band CDL AESA provides the ship crews with the capability to support multiple, simultaneous, networked operations with in-service CDL-equipped aircraft.

The Ku-band CDL AESA of the present invention provides a tiered capability of being modular, scalable, multiple-link networked communications system. Specifically, the Ku-band CDL multi-beam AESA is capable of replacing the existing single, point-to-point CDLs with a multi-point networking system to support intelligence, surveillance, and reconnaissance (ISR) transport, for the on-ship applications. The Ku-band CDL AESA of the present invention supports multi-simultaneous CDL missions by providing capability for ship-to-ship, ship-to-air, and air-to-air communication, facilitates download of ISR information to multiple surface commands, and supports tasking, collection, processing, exploitation, and dissemination (TCPED) architecture.

In some embodiments, the present invention utilizes a silicon-germanium (SiGe) MMIC to incorporate a low noise amplifier (LNA), phase shifters, digital attenuators, power dividers, and digital/analog application specific integrated circuit (ASIC). Insertion of the MMICs, which may include the LNAs and power amplifiers (PAs), in close proximity to the radiating elements, improve noise figure and transmit efficiency. According to the present invention, radiating elements, active MMICs, and multiple beamforming networks are all incorporated into a single panel of RF CCA. Moreover, the invention's shift from transmit/receive integrated multichannel modules (TRIMMs) to circuit card assembly (CCA) packaging provides size, weight, and cost reductions.

The key features of SiGe technology include the low cost associated with conventional silicon fabrication, high yields due to the process maturity, and performance competitive with gallium arsenide (GaAs). In addition, the major advantage of SiGe is the small size, light weight, and low complexity due to high integration capability of radio frequency (RF), digital, and analog devices.

SiGe BiCMOS allows for the integration of complex application-specific integrated circuit (ASIC) capabilities for enhanced system performance such as digital logic, static random-access memory (SRAM), internal bias control, power management/regulation, sensing, and tunability. The digital logic allows for current and next beam registered data for RF control and the SRAM stores volatile multiple beam data for rapid steering.

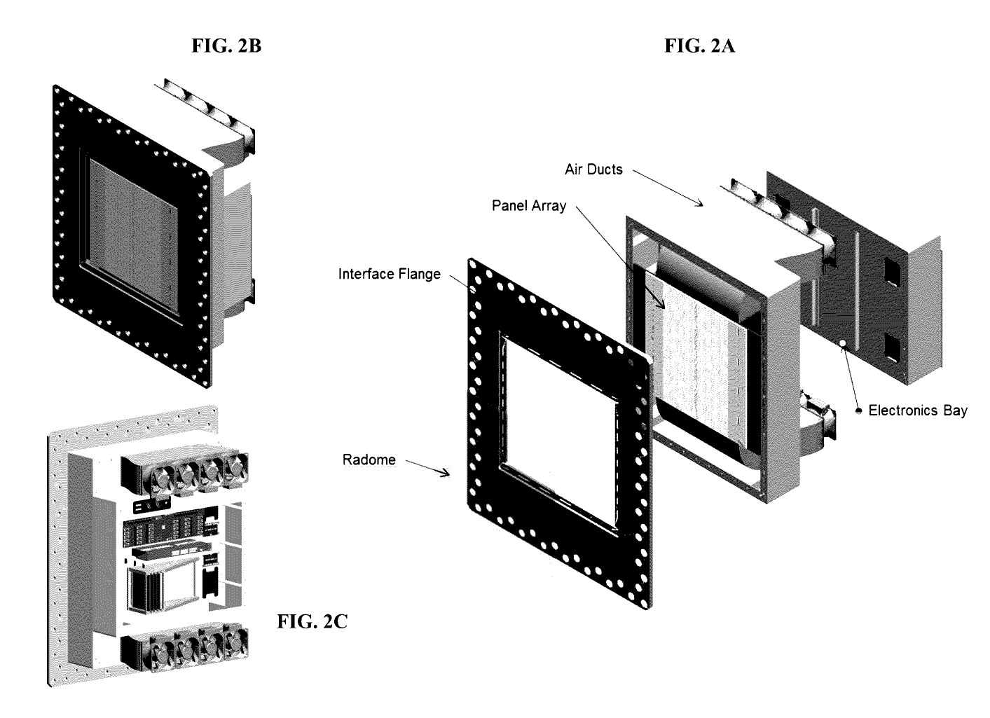

FIGS. 2A-2C illustrate a mechanical packaging of a multi-beam phased array antenna, according to some embodiments of the present invention. FIG. 2A shows a side view of the single aperture multi-beam phased array antenna. In some embodiments, the antenna enclosure is made of aluminum and mast mountable at the enclosure base. It can also be mounted to a deckhouse with the radome frame and mounting flange. All of the electrical and coolant connections for a liquid cooled version are through the enclosure at the mast mount. In some embodiments, the radome is a stretched PTFE coated fabric. An electronics bay sits behind the phased array antenna for necessary power distribution, up-conversion, down-conversion, and associated processing.

FIG. 2B shows a frontend of the single aperture multi-beam phased array antenna. In some embodiments, the enclosure is a sealed weather tight environment. A positive pressure dry environment can be provided using a dry air supplier. In some embodiments, the enclosure utilizes a bleed valve for an overpressure situation to release excessive pressure if needed. An alternate liquid cooling design can be achieved with a PG/W mixture, which is cooled via a liquid-to-liquid heat exchanger using a chilled water supply. If necessary, anti-icing may be achieved through warm dry air supply circulation or via an internal heater.

FIG. 2C depicts a backend of the single aperture multi-beam phased array antenna. As shown the back-end of the single aperture multi-beam phased array antenna would allow access to the depicted supporting electronics through an access panel or hinged cover.

The conventional TRIMM-based antenna arrays have higher power density and thus require more stringent cooling mechanisms. They also result in a thicker size, especially in the case of AESA. However, the conventional TRIMM-based antenna arrays require small number of circuit board layers, because the circuit board mainly supports the interconnectivity of the TRIMMs and not the circuits within each TRIMM. On the other hand, the CCA-based antenna arrays of the present invention require less power density due to the typical requirements of a line-of-sight communications array that results in the thinner AESA, but require large number of circuit board layers since the number of interconnections on the circuit board are much higher.

In some embodiments, the present invention utilizes unique controlled impedance RF via contacts or interconnect techniques to interconnect the large number of circuit board layers in a dense manner. The controlled impedance RF via contacts are shielded, for example, by having a ring layers around each of them, which is connected to a ground layer on the CCA. In some embodiments, the RF via contacts provide a matched 50 ohm impedance characteristic between the components on the circuit board. In some embodiments, the present invention uses tiling on the CCA for improved performance. There are various RF via types in order to connect the SiGe MMIC to the vertical and horizontal excitation probes, as well as the multiple corporate combiners. In some embodiments, all RF vias are back-drilled and filled to eliminate any stubs. The RF vias are difficult to design due to the dielectric value mix and board thickness of the CCA.

In some embodiments, the present invention includes a multi-beam silicon germanium (SiGe) MMIC, a compact high efficiency circular polarized phased array patch radiator, multiple independent corporate combiners, and high density RF via contacts on a single circuit card assembly (CCA). In some embodiments, the invention also provides beam steering agility and configurability for multiple polarizations (horizontal vertical, RHCP or LHCP) operations.

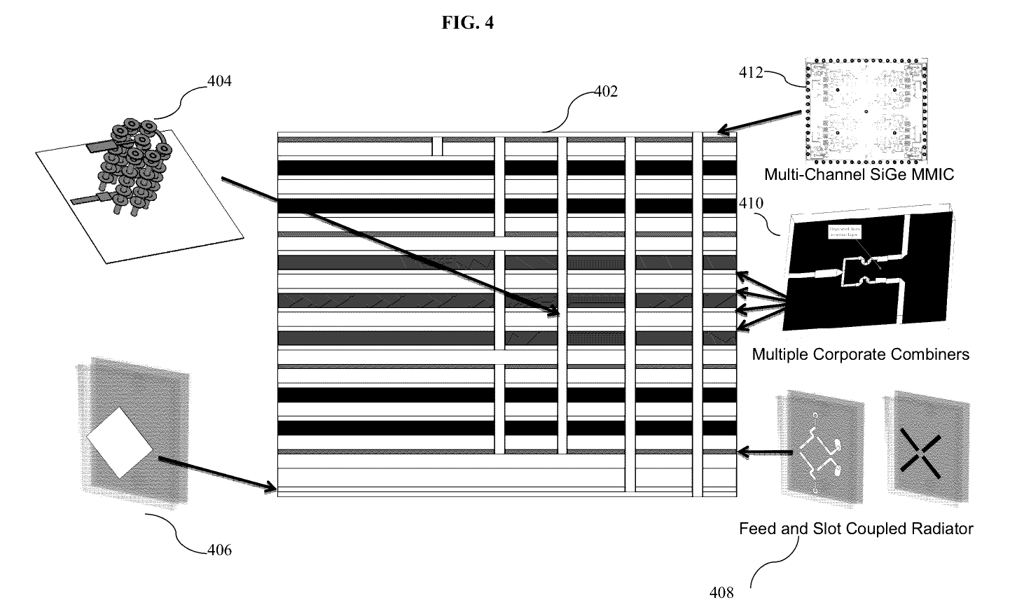

FIG. 4 illustrates the integration of the elements of a multi-beam phased array antenna into a single CCA, according to some embodiments of the present invention. These embodiments include a 20-layer CCA 402 interconnected by high density controlled impedance RF via contacts 404. For example, patch antennas 406 are located in layer 20, feed and slot coupled radiators 408 are located in layers 18 and 16, multiple beam forming circuits (corporate combiners) 410 are located in the middle layers and multi-channel SiGe MMICs 412 are located on the top layer, all of which are interconnected by the high density RF via contacts 404 with low impedances. In some embodiments, the feed and slot coupled radiators 408 include a patch antenna element and a pair of excitation circuits. The excitation circuits include a feed line and a tuning circuit configured such that a single feed line enables independent operation of each polarization.

The printed circuit board (PCB) design incorporates the compact high efficiency circular polarized phased array patch radiator and a series of highly integrated corporate combiner networks needed to support the multiple beam or RF links. The design of the (flat panel, in this case) phased array supports fast switching used for emerging network waveforms, which makes the arrays suitable for implementation of communications networks over high-bandwidth links

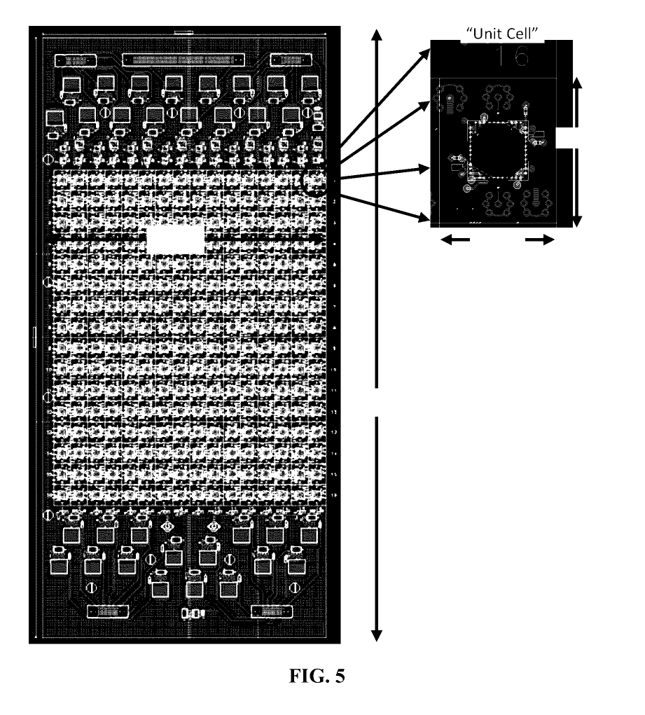

FIG. 5 shows an exemplary transmit (Tx) or receive (Rx) circuit card assembly (CCA), according to some embodiments of the present invention. In some embodiments, the invention uses use two CCAs per Tx array for 512 elements. As shown, there are 256 antenna elements arranged in an array of 16×16. Each of the antenna elements includes a SiGe Tx MMIC and interconnections (including via contacts) to the other elements and the rest of the components on the CCA. Furthermore, the Tx CCA includes two independent beam forming (corporate combiner) circuits that are printed on layers 8 and 10. In some embodiments, the Rx CCA includes four independent beam forming (corporate combiner) circuits that are printed on layers 8, 10, 12, and 14. Each MMIC may include LNAs, power amplifiers phase shifters, digital attenuators, power dividers and one or more digital/analog ASICs.

In some embodiments, the MMICs for the Rx CCA include low noise amplifiers (LNAs), while the MMICs for the Tx CCA include power amplifiers (PAs) instead. In some embodiments, the MMICs for both the Rx and the Tx CCAs include both LNAs and PAs, some of which may not be utilized. This streamlines the manufacturing of the MMICs as one that fits both Rx and Tx CCAs. In some embodiments, the Rx and Tx CCAs are physically different for full duplex communication. The radiating elements may or may not be the same depending on the communication frequencies for Rx and Tx.

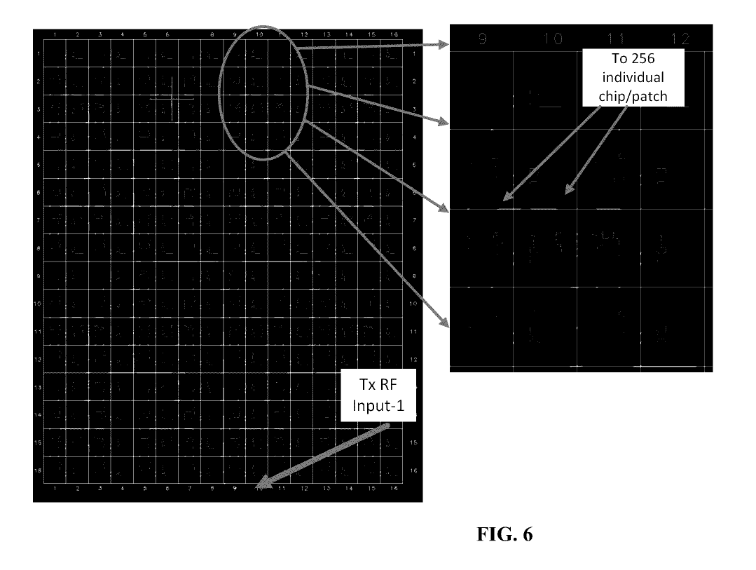

FIG. 6 shows an exemplary array of beam forming circuits etched on a circuit card assembly (CCA), according to some embodiments of the present invention. In this example, the beam forming circuit is a 256:1 network of combining or splitting elements on a single stripline PCB layer. In some embodiments, the beamforming network utilizes a buried resistive material capable of being manufactured using commercial PCB techniques. The design of the beamforming network on a single stripline layer allows for multiple beamforming networks to be combine into a single PCB design.

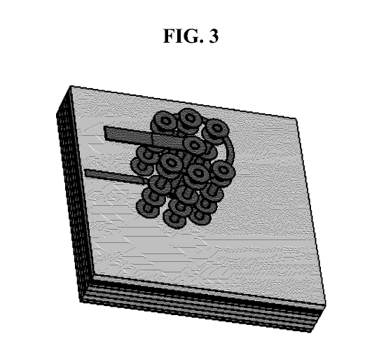

FIG. 3 depicts an exemplary controlled impedance RF via contact, according to some embodiments of the present invention. In some embodiments, the controlled impedance RF via contacts are shielded by a ring-type ground shield that is connected to a ground layer of the CCA. As shown, there are various RF via types in order to connect the SiGe MMIC to the vertical (V) and horizontal (H) excitation probes, as well as the multiple corporate combiners. For example, a first RF via type connects TX MMIC to V and H patch excitation probes on layer 16. A second RF via type connects TX MMIC to the corporate divider on layer 8, and a through RF via type connects TX MMIC to the corporate divider on layer 10. All RF vias are back-drilled and filled to eliminate any stubs. In some embodiments, the layers have different dielectric constants and thus the RF vias are difficult to design due to the dielectric value mix and board thickness of the CCA. Various techniques of ground vias and anti-ground rings are used to maintain a 50 ohm impedance vertically through the PCB. For example, coaxial-like controlled impedance structures where the outer ring of vias perform like a solid cylinders may be used for these vias. The input and output lines to the structure have matching networks to cancel any residual parasitic of the via. In some embodiments, ground vias are located on layers 13 to 18, for example, in a circular configuration, which includes seven vias, six on the perimeter of a circle and one on the center.

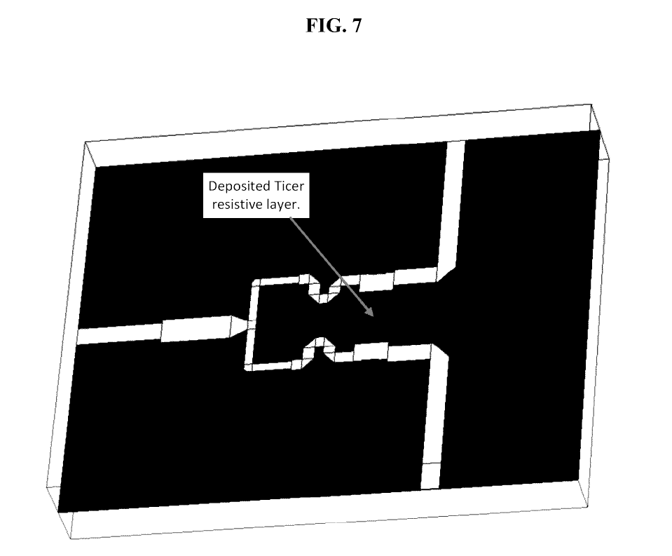

FIG. 7 illustrates a beam forming circuit that is etched on a circuit card assembly (CCA), according to some embodiments of the present invention. In some embodiments, a 50 ohm/square resistive layer is deposited or etched on a respective CCA layer to implement a beam forming circuit on the CCA. In some embodiments, each of the multiple beam forming circuits is etched on a single layer of the CCA. That is, each beam forming circuit has its own layer of the CCA. In some embodiments, the beam forming circuit is designed from a standard Wilkinson divider/combiner building block in order to combine all 256 elements. The RF traces from each stage of combining or splitting are phase matched to ensure they remain phase-coherent. A Wilkinson divider is a three port device that splits a signal into two equal phase output signals or it combines two equal phase signals into one output signal. One can also achieve isolation between the output ports while maintaining a matched condition on all ports. A Wilkinson design can also be used as a power combiner because it is made up of passive components and hence reciprocal.

A (e.g., 100 ohm) resistor allows all three ports to be simultaneously matched, as well as fully isolating port two from port three at the center frequency. A 50 ohms/square resistive material allows the resistor to be printed on a stripline layer with the Wilkinson divider internal to the PCB. In some embodiments, each of the multiple beam forming circuits is a Wilkinson beam forming circuit. The use of a standard Wilkinson divider with resistive material allows a single beamforming network to be designed and printed onto an internal PCB layer. This unique topology allows for multiple beamforming networks to be designed into a single PCB design.

It will be recognized by those skilled in the art that various modifications may be made to the illustrated and other embodiments of the invention described above, without departing from the broad inventive step thereof. It will be understood therefore that the invention is not limited to the particular embodiments or arrangements disclosed, but is rather intended to cover any changes, adaptations or modifications which are within the scope of the invention as defined by the appended claims.

What is claimed is:

1. A multi-beam antenna array comprising:
a receiver multi-layer circuit card assembly (CCA) comprising of a first plurality of monolithic microwave integrated circuits (MMICs), a first plurality of radiating elements, and a first plurality of interconnections;
a transmitter multi-layer CCA comprising of a second plurality of MMICs, a second plurality of radiating elements, and a second plurality of interconnections; and
a single aperture shared by the receiver multi-layer CCA and the transmitter multi-layer CCA, wherein
each of the first and second plurality of MMICs includes mixed analog and digital circuits surface mounted onto said each MMIC and a thermometer circuitry, wherein
each of the first and second plurality of radiating elements is a two-port radiating element for multiple polarization modes of operations, and wherein
the first and second plurality of interconnections include a single serial bus for addressing each of the respective plurality of MMICs, a first and second plurality of beam forming circuits, respectively and etched on respective layers of a respective CCA, and a plurality of controlled impedance RF via contacts to interconnect corresponding circuits and layers of a respective multi-layer CCA.

2. The multi-beam antenna array of claim 1, wherein the antenna array is an Electronically Scanned Array (ESA).

3. The multi-beam antenna array of claim 1, wherein each of the first plurality of MMICs include a low noise amplifier and each of the second plurality of MMICs include a power amplifier.

4. The multi-beam antenna array of claim 1, wherein the first and second plurality of radiating elements are feed and slot-couple radiator elements.

5. The multi-beam antenna array of claim 4, wherein each of the feed and slot coupled radiator elements includes a patch antenna element and a pair of excitation circuits, wherein each of the excitation circuits include a feed line and a tuning circuit configured such that a single feed line enables independent operation of each polarization of the multi-beam antenna array.

6. The multi-beam antenna array of claim 1, wherein said mixed analog and digital circuits in each of the MMICs include analog circuitry for controlling the amplitude, phase and attenuation of respective radiating elements for the multiple polarization modes of operations.

7. The multi-beam antenna array of claim 1, wherein said mixed analog and digital circuits are implemented using silicon-germanium (SiGe).

8. The multi-beam antenna array of claim 1, further comprising a flat panel.

9. The multi-beam antenna array of claim 1, wherein the transmitter multi-layer CCA further includes 256 antenna elements arranged in an array of 16×16 elements.

10. The multi-beam antenna array of claim 1, wherein the transmitter multi-layer CCA further includes two independent beam forming circuits, each printed on a separate single layer of the transmitter multi-layer CCA.

11. The multi-beam antenna array of claim 1, wherein the receiver multi-layer CCA further includes four independent beam forming circuits, each printed on a separate single layer of the receiver multi-layer CCA.

12. The multi-beam antenna array of claim 1, wherein RF traces of the first and second plurality of beam forming circuits are phase matched.

13. The multi-beam antenna array of claim 1, wherein each of the first and second plurality of beam forming circuits is a Wilkinson combiner including a resistor printed with resistive material on the same layer on which a respective Wilkinson combiner is placed for simultaneously matching all the ports of each combiner.

14. The multi-beam antenna array of claim 1, wherein the transmitter multi-layer CCA and the receiver multi-layer CCA are air-cooled.

15. The multi-beam antenna array of claim 1, further comprising a bleed valve to release excessive pressure.

16. The multi-beam antenna array of claim 1, further comprising an antenna enclosure made of aluminum and mountable at a base of the enclosure.

17. A multi-beam antenna array comprising:
a plurality of receiver multi-layer circuit card assemblies (CCAs), each receiver multi-layer CCA comprising of a first plurality of monolithic microwave integrated circuits (MMICs), a first plurality of radiating elements, and a first plurality of interconnections;
a plurality of transmitter multi-layer CCAs, each transmitter multi-layer CCA comprising of a second plurality of MMICs, a second plurality of radiating elements, and a second plurality of interconnections; and
a single aperture shared by the plurality of receiver multi-layer CCAs and the plurality of transmitter multi-layer CCAs, wherein
each of the first and second plurality of MMICs includes mixed analog and digital circuits surface mounted onto said each MMIC, and wherein
the first and second plurality of interconnections include a first and second plurality of beam forming circuits, respectively and etched on respective layers of a respective CCA, and a plurality of controlled impedance RF via contacts to interconnect corresponding circuits and layers of a respective multi-layer CCA.

18. The multi-beam antenna array of claim 17, wherein the first and second plurality of radiating elements are feed and slot-couple radiator elements.

19. The multi-beam antenna array of claim 18, wherein each of the feed and slot coupled radiator elements includes a patch antenna element and a pair of excitation circuits, wherein each of the excitation circuits include a feed line and a tuning circuit configured such that a single feed line enables independent operation of each polarization of the multi-beam antenna array.

20. The multi-beam antenna array of claim 17, wherein said mixed analog and digital circuits in each of the MMICs include analog circuitry for controlling the amplitude, phase and attenuation of respective radiating elements for the multiple polarization modes of operations.
